(19) United States
(12) Patent Application Publication
(10) Pub. No.: US 2019/0284742 A1
(43) Pub. Date: Sep. 19, 2019

(54) METHOD FOR FABRICATING A SPACER FABRIC COMPOSITE, COATING MACHINE AND COMPOSITE FABRICATED BY METHOD THEREOF

(71) Applicant: TSM smart materials Co., Ltd, Taoyuan (TW)

(72) Inventors: SYANG-PENG RWEI, Taipei (TW); WHE-YI CHIANG, Taipei (TW); Tzu-Wei CHOU, Taipei (TW)

(73) Assignee: TSM smart materials Co., Ltd, Taoyuan (TW)

(21) Appl. No.: 16/290,960

(22) Filed: Mar. 4, 2019

(30) Foreign Application Priority Data
Mar. 16, 2018 (TW) 107108993

(51) Int. Cl. D06B 1/14; B32B 5/02; B29B 15/12

(52) U.S. Cl. CPC D06B 1/14; B32B 5/028; B29B 15/122; B32B 2307/724; D06B 2700/27; B32B 2255/02; B32B 2255/26; B32B 2437/00; D10B 2403/033; B32B 2307/546

(57) ABSTRACT

The invention provides a method for fabricating a spacer fabric composite, coating machine and composite fabricated by method thereof. The method comprises providing a resin composition, coating step and a hole opening step.

### BACKGROUND OF THE INVENTION

### a. Field of the Invention

The invention relates to a method for fabricating a spacer fabric composite, coating machine and composite fabricated by method thereof.

### b. Description of the Related Art

Three-dimensional (3-D) fabrics or spacer fabrics have characteristics of being structurally strong, elastic, porous, and light-weight. Applications at all levels are being continuously developed in innovative applications such as apparels, shoe materials, transportation, construction, agriculture, and medical care. In this specification, the so-called “spacer fabric composite” means a composite composed of a spacer fabric and a resin layer coated on all or a part of surfaces of the spacer fabric. The coated resin layer can be formed from various inorganic and organic compounds, polymers, copolymers or resins. The coated layer can provide the 3-D fabric the additional functions compared to the area with no coating. The physical and/or chemical properties attributed to the coated resin layer can be achieved at the specific area of the 3-D fabric. For example, the combination of the thermoplastic material with the 3-D fabric described in WO2006/079602 can be used as the fracture fixation device and the orthopedic casting technology is described in U.S. Pat. No. 6,482,167. Because the 3-D fabric has the characteristics of excellent air permeability and light weight, accompanying with the mechanical strength and plasticity of the thermoplastic material, it is very suitable to replace the traditional plaster as a fixation splint or support plate for bone fractures.

However, fabrication of a spacer fabric composite usually uses a coating or impregnation method. In the impregnation method, the 3-D fabric is dipped in the solution including the coating material and solvent and then the solvent is removed from the soaked 3-D fabric to obtain the spacer fabric composite. In such a impregnation method, usage of solvent is needed and the solvent removal consumes a lot of energy and have safety concerns. In addition to the safety problem, there are problems of the high production cost and environmental unfriendliness. On the other hand, in the coating method, the coating solution may also include solvent to promote the wettability of the coating solution to the 3-D fabric. The coating method usually forms an intact film (meaning smooth film with no breaking points on the coating surface) on the surface when the solid content of the coating solution is of polymers, copolymers or resins. However, in the application of the spacer fabric composite, air permeability is necessary and the coated intact film on the 3-D fabric will result in loss of air permeability. Therefore, how to fabricate a spacer fabric composite having air permeability is urgently needed for the industry.

### BRIEF SUMMARY OF THE INVENTION

In light of the above background, in order to fulfill the requirements of the industry, one object of the invention provides a method for fabricating a spacer fabric composite, which not only fabricates a spacer fabric composite having air permeability but also reduce production cost and promote production efficiency by continuously performing coating and hole opening processes.

Furthermore, another object of the invention provides a coating machine which utilizes a roll-to-roll coating device to produce film-type products and an inline cutting process to produce plate-type products.

Other objects and advantages of the invention can be better understood from the technical characteristics disclosed by the invention. In order to achieve one of the above purposes, all the purposes, or other purposes, one embodiment of the invention provides a method for fabricating a spacer fabric composite, using a mesh spacer fabric as a substrate to form a resin layer on the substrate to fabricate a spacer fabric composite. The method includes the following steps: providing a resin composition wherein the resin composition includes at least one random copolymer or block copolymer selected from the group consisting of the following or combination thereof: polyester, polyurethane, polyamide, and polyol; a coating step to use the resin composition to form a coating film on one side or two sides of the substrate by a coating machine to obtain a coated substrate; and a hole opening step to use a hole opening device to break menisci of films between meshes of the mesh spacer fabric of the coated substrate to obtain a spacer fabric composite. The meshes of the mesh spacer fabric after coating the resin layer have a dimension shrinkage rate being less than 50%; the spacer fabric composite has air permeability being more than 100 cfm (ft³/min) according to ASTM D737 standard; and the resin composition has Young's modulus being more than 10⁸ Pa at temperature below the phase transition temperature.

Furthermore, one other embodiment of the invention provides a coating machine for form a mesh film on a mesh substrate, comprising: a coating device to make a resin composition become fluid to apply on a mesh substrate to form a coating film on surfaces of the substrate wherein the mesh substrate is a mesh spacer fabric; a transfer device to continuously transfer the substrate; and a hole opening device to form through-holes on the coated substrate to make the coated substrate become air permeable to obtain a spacer fabric composite; wherein the resin composition includes at least one random copolymer or block copolymer selected from the group consisting of the following or combination thereof: polyester, polyurethane, polyamide, and polyol and the resin composition has Young's modulus being more than 10⁸ Pa at temperature below the phase transition temperature.

One other embodiment of the invention provides a spacer fabric composite, comprising a mesh spacer fabric as a substrate and a resin layer formed on the substrate wherein the spacer fabric composite is fabricated by the method including the following steps: providing a resin composition wherein the resin composition includes at least one random copolymer or block copolymer selected from the group consisting of the following or combination thereof: polyester, polyurethane, polyamide, and polyol; a coating step to use the resin composition to form a coating film on one side or two sides of the substrate by a coating machine to obtain a coated substrate; and a hole opening step to use a hole opening device to break menisci of films between meshes of the mesh spacer fabric of the coated substrate to obtain a spacer fabric composite; wherein the meshes of the mesh spacer fabric after coating the resin layer have a dimension shrinkage rate being less than 50%; the spacer fabric composite has air permeability being more than 100 cfm (ft³/min) according to ASTM D737 standard; and the resin composition has Young's modulus being more than 10⁸ Pa at temperature below the phase transition temperature.

According to the method for fabricating a spacer fabric composite, coating machine and composite fabricated by method thereof of the present invention, the spacer fabric composite having air permeability can be continuously fabricated, the production cost can be reduced, and the production efficiency is promoted. The fabricated spacer fabric composite has the merits of light-weight, airy, excellent ability to follow the shape which the object is in contact with, and excellent operability. These characteristics of the spacer fabric composite are suitable to be applied in various application fields such as apparels, shoe materials, and transportation, construction, agriculture, and medical care.

Other objectives, features and advantages of the invention will be further understood from the further technological features disclosed by the embodiments of the invention wherein there are shown and described preferred embodiments of this invention, simply by way of illustration of modes best suitable to carry out the invention.

### BRIEF DESCRIPTION OF THE DRAWINGS

FIG. 1 shows a process flow chart illustrating a method for fabricating a spacer fabric composite according to one embodiment of the invention.

FIG. 2 shows a cross-sectional schematic diagram illustrating a spacer fabric composite according to one embodiment of the invention.

FIG. 3 shows a top-view schematic diagram illustrating the spacer fabric composite according to one embodiment of the invention shown in FIG. 2.

FIG. 4 shows a schematic diagram illustrating a coating machine according to one embodiment of the invention.

FIG. 5 shows a schematic diagram illustrating a coating device (or means) according to one embodiment of the invention.

FIG. 6 shows a schematic diagram illustrating a coating device (or means) according to one embodiment of the invention.

FIG. 7 shows a schematic diagram illustrating a coating device (or means) according to one embodiment of the invention.

FIG. 8 shows a schematic diagram illustrating a hole opening device (or means) according to one embodiment of the invention.

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. The drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The common structures and elements that are known to everyone are not described in details to avoid unnecessary limits of the invention. In the following examples, the description of the direction, such as upper, lower, left, right, front or rear, etc., is referred to the direction of the drawing. Besides, the meaning of “A layer (or element) is on B layer (element)” includes, but not limited to, “A layer is directly laminated and contact with B layer”. For example, a layer (C layer) may be existed between A layer and B layer. Some preferred embodiments of the present invention will now be described in greater detail in the following.

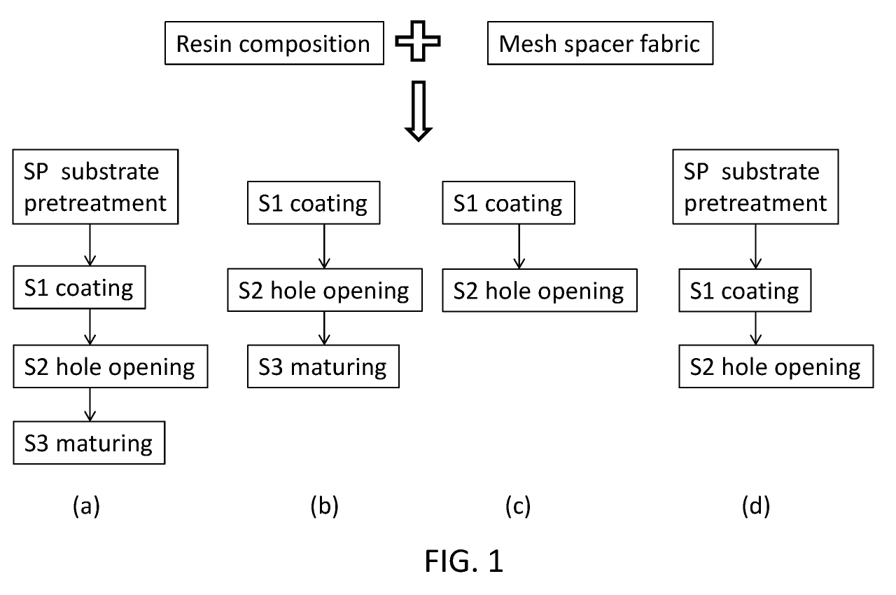

FIG. 1 shows a process flow chart illustrating a method for fabricating a spacer fabric composite according to one embodiment of the invention. The method for fabricating a spacer fabric composite according to the present invention uses a mesh spacer fabric as a substrate to form a resin layer on the substrate to fabricate a spacer fabric composite. The method includes the following steps: providing a resin composition; a coating step (S1) to use the resin composition to form a coating film on one side or two sides of the substrate by a coating machine to obtain a coated substrate; and a hole opening step (S2) to use a hole opening device to break menisci of films between meshes of the mesh spacer fabric of the coated substrate to obtain a spacer fabric composite. The method can further comprise a maturing step (S3) to store the spacer fabric composite after the hole opening step in an environment at the temperature the resin composition has flowability for a predetermined period of time. The temperature the resin composition has flowability means, for example, the softening point, glass transition temperature or melting temperature or higher. Furthermore, the method can further comprise a substrate pretreatment step (SP). As shown in FIG. 1, the substrate pretreatment step (SP), coating step (S1), hole opening step (S2) and maturing step (S3) can have various combinations, but not limited to, examples shown in FIG. 1. As a modified embodiment, each steps can be performed once or twice. Specifically, the coating step can be performed twice to form coating films on both sides of the substrate separately.

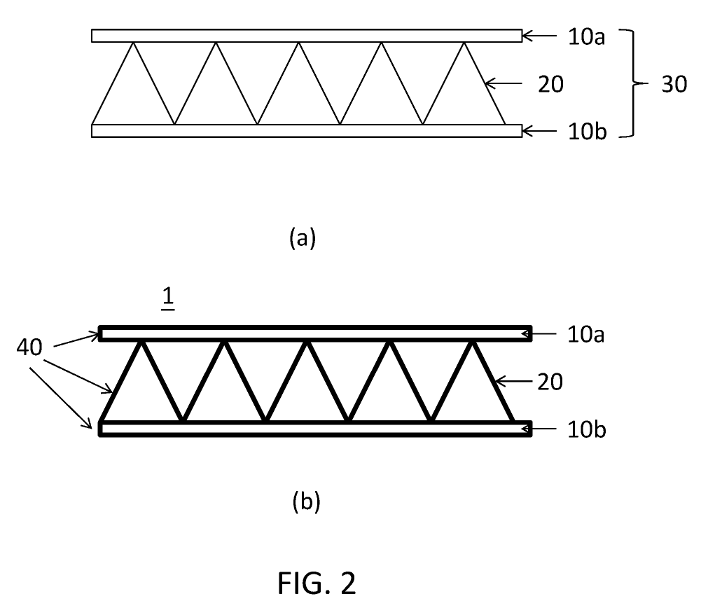

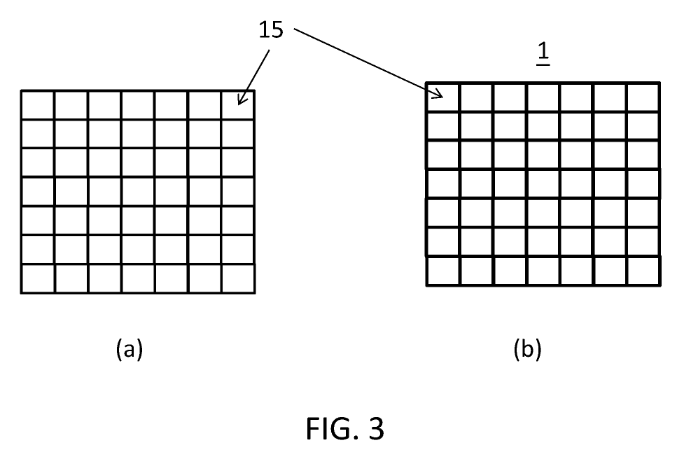

FIG. 2 shows a cross-sectional schematic diagram illustrating a spacer fabric composite according to one embodiment of the invention where (a) shows a spacer fabric 30 comprises two outer layers 10a and 10b, and an intermediate spacing layer 20 connecting the outer layer 10a and the outer layer 10b; and (b) shows a spacer fabric composite 1 has a shape memory polymer layer 40 which covers the surfaces of the two outer layers 10a and 10b, and the intermediate spacing layer 20. FIG. 3 shows a top-view schematic diagram illustrating a spacer fabric composite 1 shown in FIG. 2.

The spacer fabric 30 is consisted of two outer layers 10a and 10b, and an intermediate spacing layer 20 connecting the outer layer 10a and the outer layer 10b. The two outer layers 10a and 10b have meshes 15, such as rhomboid shaped meshes and the intermediate spacing layer is mono yarn. The structure of the spacer fabric is like a sandwich and thus also called “sandwich 3-D fabric”. The high precision warp knitting machine can be used to make the spacer fabric using mainly polymeric synthetic fibers. The two outer layers 10a and 10b were supported by dense networks from the intermediate spacing layer 20 and the surface meshes do not have large deformation to strengthen the mechanical property and enhance the color fastness. The special structure of the spacer fabric has the following advantages: (1) better air permeability and better support compared to the usual flat fabric; (2) good shock resistance, elastic recovery, and extendibility; (3) good fastness, abrasion resistance and fastness to wash; and (4) multi-functionality and versatility by combining with other composite materials. The spacer fabric (3-D fabric) can be extensively applied in the fields, such as cloths, shoe materials, mattresses, cap materials, air permeable pads, sports protective materials, medical composite materials. The spacer fabric 30 is commercially available.

The coating layer 40 can be formed by the method of the present invention to form on surfaces of the two outer layers 10a and 10b and the intermediate spacing layer 20. The resin composition includes at least one polymer, random copolymer or block copolymer selected from the group consisting of the following or combination thereof: polyester, polyurethane, polyamide, and polyol. It should be noted that, as shown in FIG. 3, the spacer fabric 30 still has the meshes 15 after the coating layer 40 is formed on the surfaces of the spacer fabric 30, that is the spacer fabric composite 1 according to the present invention has the three-dimensional mesh structure. The meshes 15 of the spacer fabric 30 (mesh spacer fabric) after coating the resin layer have a dimension shrinkage rate being less than 50%. The dimension of the mesh 15 (hollow hole) of the composite is smaller than that of the original uncoated spacer fabric. The hole shrinkage ratio ((Db−Df)/Db) of the mesh 50 is preferably less than 80%, more preferably less than 50%, and further more preferably less than 40%, where Db is the average diameter of the mesh 15 before formation of the coating layer 40 and Df is the average diameter of the mesh 15 after formation of the coating layer 40. The lower the hole shrinkage ratio the higher the air permeability of the shape memory spacer fabric composite 1. Specifically, the shape memory spacer fabric composite according to the present invention has the air permeability more than 100 cfm (ft³/min) based on ASTM D737, preferably more than 300 cfm and more preferably more than 500 cfm.

In one embodiment, the polymer or copolymer included in the resin composition has Young's modulus more than 10⁸ Pa at the temperature below the phase transition temperature. Furthermore, according to ASTM D790 (Standard Test Methods for Flexural Properties of Unreinforced and Reinforced Plastics and Electrical Insulating Materials), a specimen having a ratio of length/width/thickness equal to 40/4/1 is used in the three-point bending test, the testing speed is set to 15 mm/min, the ratio of the support span length to the length of the specimen is set to 16/40, and the value at the 5% deformation without breaking is the flexural strength. The spacer fabric composite has a flexural strength more than 120 MPa, preferably more than 200 MPa. The coating layer 40 is preferably made of polyesters or polyurethanes. However, the method of the present invention is not limited to use the above polymers or copolymers.

In the maturing step, after the hole opening step, the spacer fabric composite is stored in an environment at temperature the resin composition has flowability for a predetermined period of time. The temperature the resin composition has flowability means, for example, the softening point, glass transition temperature or melting temperature or higher. The duration of the maturing process depends on the processing temperature and can be for example 5 min to 24 h and preferably 10 min to 8 h, considering the production efficiency. For example, it is stored at the melting temperature +10° C.-50° C. for 10 minutes-8 hours.

In the substrate pretreatment step, the substrate before the coating step is passed through a pretreatment device (or means) to activate surfaces of the substrate to promote adhesion between the substrate and the resin composition. The pretreatment device (or means) performs treatment selected from the group consisting of the following or combination thereof: plasma treatment, corona treatment, ultraviolet radiation, ozone treatment, anchoring treatment, swelling treatment and preheating treatment. Preferably, the preheating treatment is performed.

In one embodiment, the coating machine includes a lamination device, a hot press device or a hot roller device.

In one embodiment, the hole opening device is selected from the group consisting of the following or combination thereof: contact type hole opening device and non-contact type hole opening device. The contact type hole opening device may include, for example, a plate or a roller having a needle network structure. The non-contact type hole opening device may be, for example, selected from the group consisting of the following or combination thereof: a low frequency oscillator, high frequency oscillator and oven.

In one embodiment, after the coating step, the method further comprises a pressing step to infiltrate the resin composition to the first and second outer layers and the intermediate layer of the substrate by at least one pressing roller.

Furthermore, according to one other embodiment of the invention, a coating machine for form a mesh film on a mesh substrate is disclosed. The coating machine comprises a coating device, a transfer device and a hole opening device. The coating device makes a resin composition become fluid to apply on a mesh substrate to form a coating film on surfaces of the substrate. The mesh substrate is for example a mesh spacer fabric. The transfer device continuously transfers the substrate. The hole opening device forms through-holes on the coated substrate to make the coated substrate become air permeable to obtain a spacer fabric composite. The resin composition includes at least one polymer, random copolymer or block copolymer selected from the group consisting of the following or combination thereof: polyester, polyurethane, polyamide, and polyol. The resin composition has Young's modulus being more than 10⁸ Pa at temperature below the phase transition temperature. The so-called “through-hole” means hollow holes to connect two surfaces of the substrate (the two outer layers of the spacer fabric) which is not limited to the hollow holes perpendicular to the two surfaces of the substrate as long as the hollow hole allows air flowing between two sides of the substrate.

In the coating machine, the hole opening device is selected from the group consisting of the following or combination thereof: contact type hole opening device and non-contact type hole opening device. The contact type hole opening device may include, for example, a plate or a roller having a needle network structure. The non-contact type hole opening device may be, for example, selected from the group consisting of the following or combination thereof: a low frequency oscillator, high frequency oscillator and oven.

In one embodiment, the coating machine further comprises at least one pressing roller to infiltrate the resin composition to the first and second outer layers and the intermediate layer of the substrate.

In one embodiment, in the coating machine, the coating device is an extruder.

In one embodiment, the coating machine further comprises a cooling device and or a cutting device.

In one embodiment, the coating machine further comprises a plurality of hot rollers or heating zones and cooling zones in the path for transferring the substrate during processing.

In addition, the components of the coating machine can be processed with release treatment, for example, surface treatment of fluoride coating or silicone coating but not limited to the above examples. For example, the plate or roller having a needle network structure is processed with release treatment. On the other hand, the components of the coating machine can be processed with surface polishing treatment.

In the above method or during use of the coating machine, the coating film can be formed on one or two sides of surfaces of the substrate. When the coating films are formed on the two sides of surfaces of the substrate, they can be formed simultaneously or separately. The thickness of the film will affect the hole opening rate and can be adjusted according to the thickness of the spacer fabric, the expected hole opening rate and the hardness of the spacer fabric composite. Generally, the thickness can be 0.02 mm-2.0 mm, preferably 0.05˜1.0 mm, more preferably 0.1˜1.0 mm or less than 50% of the thickness of the spacer fabric, preferably less than 20%, more preferably less than 10%. The thickness can be adjusted depending on the required strength of the composite.

Furthermore, according to one other embodiment of the invention, a spacer fabric composite is disclosed. The spacer fabric composite is fabricated by the above method or the coating machine of the present invention.

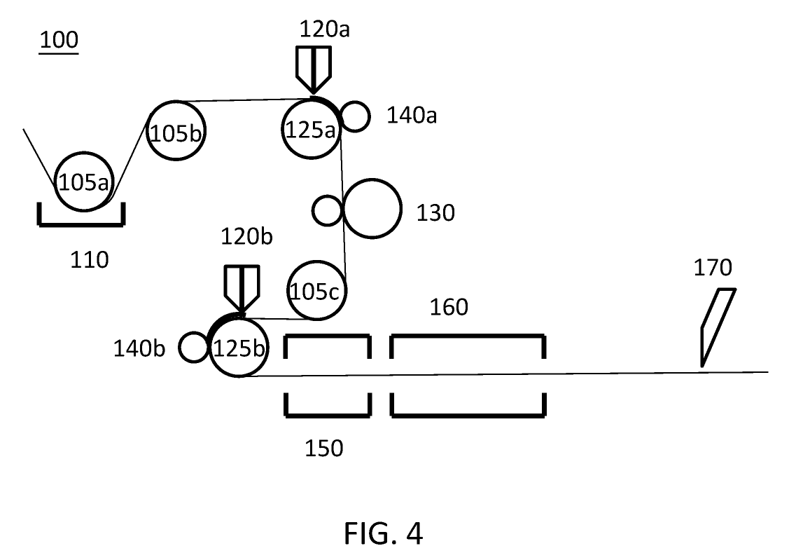

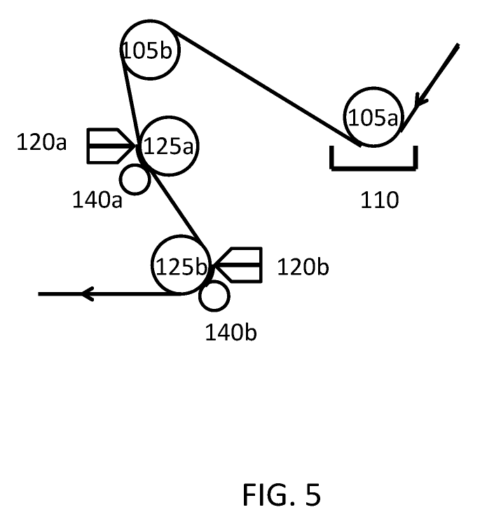

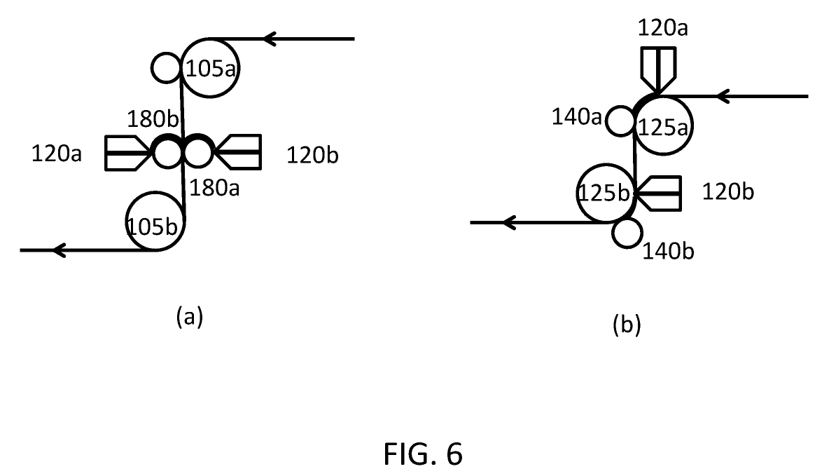

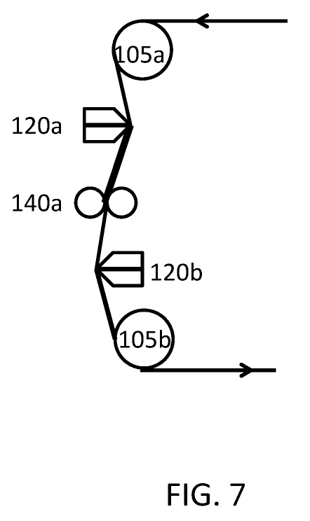

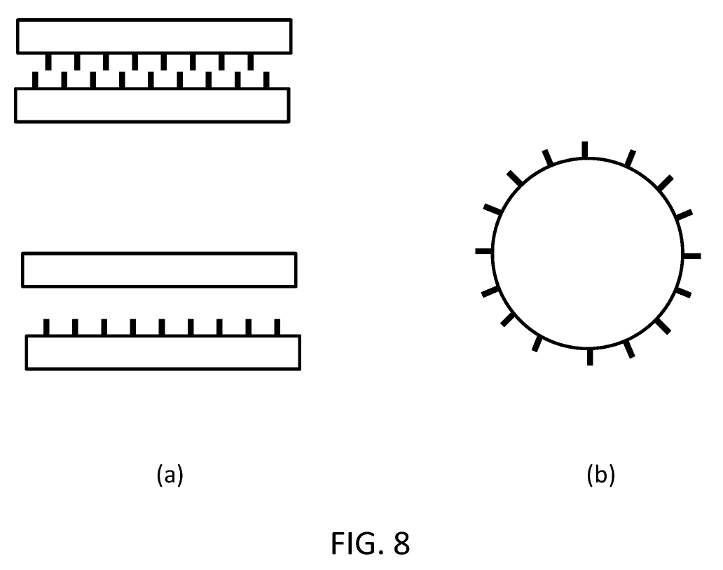

FIG. 4 shows a schematic diagram illustrating a coating machine according to one embodiment of the invention but the coating machine of the present invention is not limited to include all of the components in the figure can have various combinations and selections according to actual needs. For example, the coating machine does not include a substrate pretreatment device. The coating machine 100 includes a substrate pretreatment device 110, transferring rollers 105a, 105b, 105c, a slot die 120a, 120b, coating rollers 125a, 125b, pressing rollers 140a, 140b, a hot roller 130 (may be replaced by an oven or not in use), a hole opening device 150, a cooling device 160 and a cutter 170, and so forth. FIGS. 5-7 show variations of a coating device (or means) according to the present invention where 180a and 180b represents pressing and coating rollers. FIG. 8 shows a schematic diagram illustrating a hole opening device 150 (or means) according to one embodiment of the invention.

In conclusion, according to the method for fabricating a spacer fabric composite, coating machine and composite fabricated by method thereof of the present invention, the spacer fabric composite having air permeability can be continuously fabricated, the production cost can be reduced, and the production efficiency is promoted. The fabricated spacer fabric composite has the merits of light-weight, airy, excellent ability to follow the shape which the object is in contact with, and excellent operability. These characteristics of the spacer fabric composite are suitable to be applied in various application fields such as apparels, shoe materials, and transportation, construction, agriculture, and medical care.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims. Each of the terms “first” and “second” is only a nomenclature used to modify its corresponding element. These terms are not used to set up the upper limit or lower limit of the number of elements.

What is claimed is:

1. A method for fabricating a spacer fabric composite, using a mesh spacer fabric as a substrate to form a resin layer on the substrate to fabricate a spacer fabric composite, the method including the following steps:
providing a resin composition wherein the resin composition includes at least one polymer, random copolymer or block copolymer selected from the group consisting of the following or combination thereof: polyester, polyurethane, polyamide, and polyol;
a coating step to use the resin composition to form a coating film on one side or two sides of the substrate by a coating machine to obtain a coated substrate; and
a hole opening step to use a hole opening device to break menisci of the film between meshes of the mesh spacer fabric of the coated substrate to obtain a spacer fabric composite;
wherein the mesh spacer fabric comprises a first outer layer, an intermediate spacing layer and a second outer layer, the meshes of the mesh spacer fabric after coating the resin layer have a dimension shrinkage rate being less than 50%; the spacer fabric composite has air permeability being more than 100 cfm (ft³/min) according to ASTM D737 standard; and the resin composition has Young's modulus being more than 10⁸ Pa at temperature below the phase transition temperature.

2. The method as claimed in claim 1, further comprising: a maturing step to store the spacer fabric composite after the hole opening step in an environment at temperature the resin composition has flowability for a predetermined period of time.

3. The method as claimed in claim 1, further comprising: a pretreatment step to process the substrate before the coating step by passing the substrate through a pretreatment device to activate surfaces of the substrate to promote adhesion between the substrate and the resin composition.

4. The method as claimed in claim 1, wherein the coating machine includes a lamination device, a hot press device or a hot roller device.

5. The method as claimed in claim 2, wherein the coating machine includes a lamination device, a hot press device or a hot roller device.

6. The method as claimed in claim 1, wherein the hole opening device is selected from the group consisting of the following or combination thereof: contact type hole opening device and non-contact type hole opening device.

7. The method as claimed in claim 2, wherein the hole opening device is selected from the group consisting of the following or combination thereof: contact type hole opening device and non-contact type hole opening device.

8. The method as claimed in claim 7, wherein the contact type hole opening device includes a plate or a roller having a needle network structure.

9. The method as claimed in claim 7, wherein the non-contact type hole opening device is selected from the group consisting of the following or combination thereof:
a low frequency oscillator, high frequency oscillator and oven.

10. The method as claimed in claim 3, wherein the pretreatment device performs treatment selected from the group consisting of the following or combination thereof:
plasma treatment, corona treatment, ultraviolet radiation, ozone treatment, anchoring treatment, swelling treatment and preheating treatment.

11. The method as claimed in claim 1, after the coating step, further comprising a pressing step to infiltrate the resin composition to the first and second outer layers and the intermediate layer of the substrate by at least one pressing roller.

12. A coating machine for forming a mesh film on a mesh substrate, comprising:
a coating device to make a resin composition become fluid to apply on a mesh substrate to form a coating film on surfaces of the substrate wherein the mesh substrate is a mesh spacer fabric;
a transfer device to continuously transfer the substrate; and
a hole opening device to form through-holes on the coated substrate to make the coated substrate become air permeable to obtain a spacer fabric composite;
wherein the resin composition includes at least one polymer, random copolymer or block copolymer selected from the group consisting of the following or combination thereof: polyester, polyurethane, polyamide, and polyol and the resin composition has Young's modulus being more than 10⁸ Pa at temperature below the phase transition temperature;
the mesh spacer fabric comprises a first outer layer, an intermediate spacing layer and a second outer layer, the meshes of the coated mesh substrate have a dimension shrinkage rate being less than 50%; and the spacer fabric composite has air permeability being more than 100 cfm (ft³/min) according to ASTM D737 standard.

13. The machine as claimed in claim 12, wherein the hole opening device is selected from the group consisting of the following or combination thereof: contact type hole opening device and non-contact type hole opening device.

14. The machine as claimed in claim 13, wherein the contact type hole opening device includes a plate or a roller having a needle network structure.

15. The machine as claimed in claim 13, wherein the non-contact type hole opening device is selected from the group consisting of the following or combination thereof: a low frequency oscillator, high frequency oscillator and oven.

16. The machine as claimed in claim 12, further comprising at least one pressing roller to infiltrate the resin composition to the first and second outer layers and the intermediate layer of the substrate.

17. The machine as claimed in claim 12, further comprising a pretreatment device to perform treatment selected from the group consisting of the following or combination thereof: plasma treatment, corona treatment, ultraviolet radiation, ozone treatment, anchoring treatment, swelling treatment and preheating treatment.

18. The machine as claimed in claim 12, wherein the coating device is a extruder.

19. A spacer fabric composite, comprising a mesh spacer fabric as a substrate and a resin layer formed on the substrate wherein the spacer fabric composite is fabricated by the method including the following steps:
providing a resin composition wherein the resin composition includes at least one polymer, random copolymer or block copolymer selected from the group consisting of the following or combination thereof: polyester, polyurethane, polyamide, and polyol;
a coating step to use the resin composition to form a coating film on one side or two sides of the substrate by a coating machine to obtain a coated substrate; and
a hole opening step to use a hole opening device to break menisci of films between meshes of the mesh spacer fabric of the coated substrate to obtain a spacer fabric composite;
wherein the mesh spacer fabric comprises a first outer layer, an intermediate spacing layer and a second outer layer, the meshes of the mesh spacer fabric after coating the resin layer have a dimension shrinkage rate being less than 50%; the spacer fabric composite has air permeability being more than 100 cfm (ft³/min) according to ASTM D737 standard; and the resin composition has Young's modulus being more than 10⁸ Pa at temperature below the phase transition temperature.
